(19) United States
(12) Patent Application Publication
(10) Pub. No.: US 2026/0136369 A1
(43) Pub. Date: May 14, 2026

(54) DOWNLINK REFERENCE SIGNAL SENDING METHOD AND APPARATUS, TERMINAL, AND NETWORK SIDE DEVICE

(71) Applicant: VIVO MOBILE COMMUNICATION CO., LTD., Dongguan (CN)

(72) Inventors: Gen LI, Dongguan (CN); Xueming PAN, Dongguan (CN)

(73) Assignee: VIVO MOBILE COMMUNICATION CO., LTD., Dongguan (CN)

(21) Appl. No.: 19/032,392

(22) Filed: Jan. 20, 2025

Related U.S. Application Data
(63) Continuation of application No. PCT/CN2023/109048, filed on Jul. 25, 2023.

(30) Foreign Application Priority Data
Jul. 29, 2022 (CN) 202210910935.8

(51) Int. Cl. H04W 72/23; H04W 72/044; H04W 74/0833

(52) U.S. Cl. CPC H04W 72/23; H04W 72/044; H04W 74/0833

(57) ABSTRACT

This application provides a downlink reference signal sending method and apparatus, a terminal, and a network side device. The downlink reference signal sending method includes: the terminal obtains first parameter configuration information associated with a first signal, and when a first condition is met, the terminal sends the first signal to the network side device in a target cell based on the first parameter configuration information. The terminal has camped on or has accessed a first cell of the network side device. The first signal is used to trigger sending of a downlink reference signal of a second cell group of the networking side device. The second cell group includes at least one cell.

### CROSS-REFERENCE TO RELATED APPLICATIONS

This application is a continuation of International Application No. PCT/CN 2023/109048, filed on Jul. 25, 2023, which claims priority to Chinese Patent Application No. 202210910935.8, filed on Jul. 29, 2022. The entire contents of each of the above-referenced applications are expressly incorporated herein by reference.

### TECHNICAL FIELD

This application relates to the field of communications technologies, and specifically, to a downlink reference signal sending method and apparatus, a terminal, and a network side device.

### BACKGROUND

In a multi-carrier deployment scenario, a base station needs to periodically send a downlink reference signal of each carrier to a terminal. The terminal can implement establishment of a downlink time-frequency synchronization relationship, identification of a cell ID, and other functions by listening to the downlink reference signal sent by the base station.

However, in a case that a periodic downlink reference signal is sent for each carrier, power consumption of the base station is increased. Therefore, to reduce the power consumption of the base station, sending of a periodic Synchronization Signal and PBCH block (SSB) could be reduced while ensuring performance of the terminal.

### SUMMARY

Embodiments of this application provide a downlink reference signal sending method and apparatus, a terminal, and a network side device.

According to a first aspect, a downlink reference signal sending method is provided. The method includes:

A terminal obtains first parameter configuration information associated with a first signal.

In a case that a first condition is met, the terminal sends the first signal to a network side device in a target cell based on the first parameter configuration information.

The terminal has camped on or has accessed a first cell of the network side device, the first signal is used to trigger sending of a downlink reference signal of a second cell group of the networking side device, and the second cell group includes at least one cell.

According to a second aspect, a downlink reference signal sending method is provided. The method includes:

A network side device receives a first signal from a terminal, where the terminal has camped on or has accessed a first cell of the network side device, the first signal is used to trigger sending of a downlink reference signal of a second cell group of the networking side device, and the second cell group includes at least one cell.

The network side device sends the downlink reference signal of the second cell group to the terminal in a specific cell in the second cell group based on a target transmission parameter for the downlink reference signal of the second cell group.

The specific cell includes at least one of the following:
a cell indicated by the first signal;
a cell configured by the network side device in the second cell group;
all cells in the second cell group;
a cell with a largest or smallest or middle cell index in the second cell group;
a cell with a largest or smallest or middle cell center frequency in the second cell group; and
a cell with a largest or smallest cell subcarrier spacing SCS in the second cell group.

According to a third aspect, a downlink reference signal sending apparatus is provided. The apparatus includes:
an obtaining module, configured to obtain first parameter configuration information associated with a first signal; and
a first sending module, configured to: in a case that a first condition is met, send the first signal to a network side device in a target cell based on the first parameter configuration information.

The apparatus has camped on or has accessed a first cell of the network side device, the first signal is used to trigger sending of a downlink reference signal of a second cell group of the networking side device, and the second cell group includes at least one cell.

According to a fourth aspect, a downlink reference signal sending apparatus is provided. The apparatus includes:
a receiving module, configured to receive a first signal from a terminal, where the terminal has camped on or has accessed a first cell of the apparatus, the first signal is used to trigger sending of a downlink reference signal of a second cell group of the networking side device, and the second cell group includes at least one cell; and
a second sending module, configured to send the downlink reference signal of the second cell group to the terminal in a specific cell in the second cell group based on a target transmission parameter for the downlink reference signal of the second cell group.

The specific cell includes at least one of the following:
a cell indicated by the first signal;
a cell configured by the network side device in the second cell group;
all cells in the second cell group;
a cell with a largest or smallest or middle cell index in the second cell group;
a cell with a largest or smallest or middle cell center frequency in the second cell group; and
a cell with a largest or smallest cell subcarrier spacing SCS in the second cell group.

According to a fifth aspect, a terminal is provided. The terminal includes a processor and a memory, the memory stores a program or an instruction that is executable on the processor, and the program or the instruction is executed by the processor to implement the steps of the method according to the first aspect.

According to a sixth aspect, a terminal is provided, and includes a processor and a communication interface. The processor is configured to obtain first parameter configuration information associated with a first signal. The communication interface is configured to: in a case that a first condition is met, send the first signal to a network side device in a target cell based on the first parameter configuration information. The terminal has camped on or has accessed a first cell of the network side device, the first signal is used to trigger sending of a downlink reference signal of a second cell group of the networking side device, and the second cell group includes at least one cell.

According to a seventh aspect, a network side device is provided. The network side device includes a processor and a memory, the memory stores a program or an instruction that is executable on the processor, and the program or the instruction is executed by the processor to implement the steps of the method according to the second aspect.

According to an eighth aspect, a network side device is provided, and includes a processor and a communication interface. The communication interface is configured to:
receive a first signal from a terminal, where the terminal has camped on or has accessed a first cell of the network side device, the first signal is used to trigger sending of a downlink reference signal of a second cell group of the networking side device, and the second cell group includes at least one cell; and
send the downlink reference signal of the second cell group to the terminal in a specific cell in the second cell group based on a target transmission parameter for the downlink reference signal of the second cell group.

The specific cell includes at least one of the following:
a cell indicated by the first signal;
a cell configured by the network side device in the second cell group;
all cells in the second cell group;
a cell with a largest or smallest or middle cell index in the second cell group;
a cell with a largest or smallest or middle cell center frequency in the second cell group; and
a cell with a largest or smallest cell subcarrier spacing SCS in the second cell group.

According to a ninth aspect, a downlink reference signal sending system is provided, including a terminal and a network side device. The terminal may be configured to perform the steps of the method according to the first aspect, and the network side device may be configured to perform the steps of the method according to the second aspect.

According to a tenth aspect, a readable storage medium is provided. The readable storage medium stores a program or an instruction, and the program or the instruction is executed by a processor to implement the steps of the method according to the first aspect or the steps of the method according to the second aspect.

According to an eleventh aspect, a chip is provided. The chip includes a processor and a communication interface, the communication interface is coupled to the processor, and the processor is configured to run a program or an instruction to implement the method according to the first aspect or the method according to the second aspect.

According to a twelfth aspect, a computer program/program product is provided. The computer program/program product is stored in a storage medium, and the computer program/program product is executed by at least one processor to implement the steps of the method according to the first aspect or implement the steps of the method according to the second aspect.

In the embodiments of this application, the terminal obtains the first parameter configuration information associated with the first signal; and in the case that the first condition is met, sends the first signal to the network side device in the target cell based on the first parameter configuration information, to trigger the network side device to send the downlink reference signal of the second cell group to the terminal. That is, in a case that the network side device receives the first signal from the terminal, the network side device sends the downlink reference signal of the second cell group to the terminal. The network side device is enabled to reduce sending of the periodic downlink reference signal by using a mechanism of sending the downlink reference signal on demand, to reduce power consumption of the network side device and achieve an effect of network power saving.

### BRIEF DESCRIPTION OF DRAWINGS

FIG. 1 is a schematic diagram of a wireless communication system to which embodiments of this application are applicable;

FIG. 2 is a first schematic flowchart of a downlink reference signal sending method according to an embodiment of this application;

FIG. 3 is a second schematic flowchart of a downlink reference signal sending method according to an embodiment of this application;

FIG. 4 is a first schematic diagram of a structure of a downlink reference signal sending apparatus according to an embodiment of this application;

FIG. 5 is a second schematic diagram of a structure of a downlink reference signal sending apparatus according to an embodiment of this application;

FIG. 6 is a schematic diagram of a structure of a communication device according to an embodiment of this application;

FIG. 7 is a schematic diagram of a structure of a terminal according to an embodiment of this application; and

FIG. 8 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following descriptions for illustrative purposes, and the NR terminology is used in most of the following descriptions, although these technologies can also be applied to a communication system other than the NR system application, such as a 6th Generation (6G) communication system.

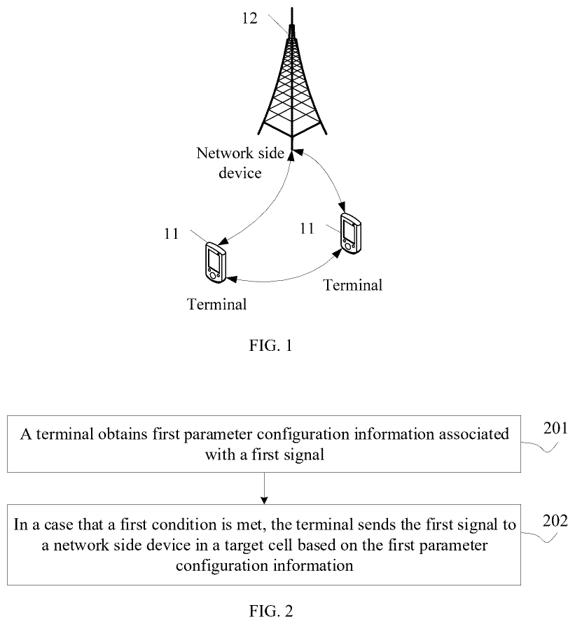

FIG. 1 is a schematic diagram of a wireless communication system to which embodiments of this application are applicable. The wireless communication system shown in FIG. 1 includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. It should be noted that a specific type of the terminal 11 is not limited in the embodiments of this application.

The network side device 12 may include an access network device or a core network device. The access network device may also be referred to as a radio access network device, a Radio Access Network (RAN), a radio access network function, or a radio access network unit. The access network device may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. Provided that a same technical effect is achieved, the base station is not limited to a specified technical term. It should be noted that, in the embodiments of this application, only a base station in an NR system is used as an example for description, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), a Location Management Function (LMF), an Enhanced Serving Mobile Location Centre (E-SMLC), a Network Data Analytics Function (NWDAF), and the like. It should be noted that, in the embodiments of this application, only a core network device in an NR system is used as an example for description, and a specific type of the core network device is not limited.

To facilitate a clearer understanding of the embodiments of this application, some relevant background knowledge is first described below.

For a Primary cell (PCell) or a Primary Secondary Cell (PSCell), a base station needs to send a periodic Synchronization Signal Block (SSB), and an SSB periodicity needs to be less than or equal to 20 ms before a terminal can initially perform successful search.

For an intra-band secondary carrier (Secondary Cell (Scell)), the base station may send an SSB, and configure an SSB-related parameter when adding the SCell; or may not send an SSB, and does not configure an SSB-related parameter when adding the SCell. The terminal obtains timing through the SSB in the PCell.

For an inter-band SCell, the base station needs to send an SSB, and configure an SSB-related parameter when adding the SCell.

In an example multi-carrier deployment scenario, an SSB needs to be sent for an inter-band carrier, and power consumption of the base station is high. Therefore, in another example multi-carrier deployment scenario, sending of the periodic SSB can be reduced to reduce the power consumption of the base station without affecting performance of the terminal.

The following describes in detail a downlink reference signal sending method provided in the embodiments of this application by using some embodiments and application scenarios thereof with reference to the accompanying drawings.

In the downlink reference signal sending method provided in the embodiments of this application, a terminal obtains first parameter configuration information associated with a first signal; and in a case that a first condition is met, sends the first signal to a network side device in a target cell based on the first parameter configuration information, to trigger the network side device to send a downlink reference signal of a second cell group to the terminal. That is, in a case that the network side device receives the first signal from the terminal, the network side device sends the downlink reference signal of the second cell group to the terminal. The network side device is enabled to reduce sending of the periodic downlink reference signal by using a mechanism of sending the downlink reference signal on demand, to reduce power consumption of the network side device and achieve an effect of network power saving.

FIG. 2 is a first schematic flowchart of a downlink reference signal sending method according to an embodiment of this application. As shown in FIG. 2, the method includes steps 201 and 202.

Step 201: A terminal obtains first parameter configuration information associated with a first signal.

It should be noted that this embodiment of this application may be applied to a scenario in which a network side device sends a downlink reference signal to the terminal in a case of multi-carrier deployment. The terminal includes but is not limited to the type of the foregoing listed terminal 11. This is not limited in this application. In this embodiment of this application, a cell may include a carrier, a cell group may include a carrier group, and a cell group may include at least one cell.

In a multi-carrier deployment scenario, a periodic synchronization reference signal is sent for each carrier, resulting in increased power consumption of the network side device (such as a base station). Therefore, in the multi-carrier deployment scenario, in this embodiment of this application, the terminal needs to obtain the first parameter configuration information associated with the first signal, to reduce power consumption of the network side device by sending fewer downlink reference signals, and reduce sending of the downlink reference signal on the premise of ensuring performance of the terminal.

The terminal has camped on or has accessed a first cell of the network side device. The first parameter configuration information is determined by using at least one of the following: configured by the network side device via the first cell and predefined in a protocol.

Step 202: In a case that a first condition is met, the terminal sends the first signal to the network side device in a target cell based on the first parameter configuration information.

For example, after the terminal obtains the first parameter configuration information associated with the first signal, in the case that the first condition is met, the terminal needs to send the first signal to the network side device in the target cell based on the first parameter configuration information, where the target cell is a “sending carrier”, and the first signal is used to trigger sending of a downlink reference signal of a second cell group of the networking side device.

It should be noted that the first condition indicates that the terminal expects to receive the downlink reference signal of the second cell group from the network side device, the second cell group includes at least one cell, and the first cell and the second cell group are different cells served by the network side device.

Correspondingly, after receiving the first signal sent by the terminal, the network side device sends the downlink reference signal of the second cell group to the terminal based on the first signal.

For example, the target cell includes at least one of the following:
(a) the first cell;
(b) a cell configured by the network side device in the second cell group;
(c) all cells in the second cell group;
(d) a cell with a largest or smallest or middle cell index in the second cell group;
(e) a cell with a largest or smallest or middle cell center frequency in the second cell group; and
(f) a cell with a largest or smallest cell subcarrier spacing (Subcarrier Spacing, SCS) in the second cell group; and
(g) a cell configured by the network side device and/or predefined in the protocol for the terminal to send the first signal.

For example, a cell in the second cell group includes at least one of the following: (a) a cell in a same band;
(b) a cell configured by the network side device;
(c) a cell with a same SCS of an initial Bandwidth Part (BWP);
(d) a cell with a same SCS of an active BWP; and
(e) a cell with a same SCS of a synchronization signal and physical broadcast channel block SSB.

For example, the downlink reference signal includes at least one of the following:
a synchronization signal and physical broadcast channel block SSB;
a Tracking Reference Signal (TRS);
a Channel State Information Reference Signal (CSI-RS).

In the downlink reference signal sending method provided in this embodiment of this application, the terminal obtains the first parameter configuration information associated with the first signal; and in the case that the first condition is met, sends the first signal to the network side device in the target cell based on the first parameter configuration information, to trigger the network side device to send the downlink reference signal of the second cell group to the terminal. That is, in a case that the network side device receives the first signal from the terminal, the network side device sends the downlink reference signal of the second cell group to the terminal. The network side device is enabled to reduce sending of the periodic downlink reference signal by using a mechanism of sending the downlink reference signal on demand, to reduce power consumption of the network side device and achieve an effect of network power saving.

For example, the first parameter configuration information includes at least one of the following:
(a) a synchronization reference signal configuration;
(b) a signal type, where
for example, the signal type may be, for example, a Random Access Channel (RACH), a Sounding Reference Signal (SRS), a Physical Uplink Control Channel (PUCCH), or the like;
(c) a first resource configuration, including at least one of the following: a signal time domain resource configuration, a signal frequency domain resource configuration, and a signal sequence resource configuration;
(d) a first power configuration, including a signal initial power and/or a signal power step, where
for example, the signal power step is, for example, a signal power ramp-up power step;
(e) a signal repetition configuration, including a repetition quantity corresponding to each time of sending the first signal and/or a maximum quantity of repetitions of the first signal; and
(f) a signal space domain parameter configuration, including a correspondence between the first signal and a downlink reference signal of the first cell or between the first signal and the downlink reference signal of the second cell group.

For example, the synchronization reference signal configuration includes at least one of the following:
(a) the downlink reference signal of the first cell;
(b) a downlink reference signal sent in an intra-band cell of the second cell group;
(c) a downlink reference signal of a third cell, where the third cell is a cell configured by the network side device and/or predefined in a protocol for the terminal to send the first signal;
(d) a downlink reference signal sent in an intra-band cell of the third cell; and
(e) global positioning system timing GPS timing.

For example, the first resource configuration is obtained by using at least one of the following:
(a) configuring a signal resource list in the first cell, where each entry in the signal resource list one-to-one corresponds, in an order of cell group indexes, to each cell group configured for sending a downlink reference signal on demand in the second cell group, or each entry in the signal resource list corresponds to an index of a cell group in the second cell group, and any entry in the signal resource list includes at least one resource, where
for example, one or more resources in the signal resource list may be configured directly, or an index of a candidate signal resource set is configured;
(b) configuring a candidate signal resource set in the first cell, where a candidate signal resource of at least one periodicity in the candidate signal resource set is numbered in a combination order of any one of a time domain, a frequency domain, and a code domain, and a granularity of at least one candidate signal resource one-to-one corresponds, in an order of cell indexes or cell group indexes, to a cell or a cell group configured for sending a downlink reference signal on demand, where
for example, the candidate signal resource includes at least one of the following: a signal time domain resource configuration, a signal frequency domain resource configuration, and a signal sequence resource configuration; and
(c) separately configuring at least one resource of the target cell in a cell configuration of the second cell group by the first cell, where
for example, one or more resources may be configured directly, or an index of a candidate signal resource set is configured.

For example, the candidate signal resource is obtained by using at least one of the following:
(a) the signal time domain resource configuration is the same as a common random access channel RACH configuration for the first cell or the second cell group, where
for example, the signal time domain resource configuration is a first signal time domain resource configuration, and that the signal time domain resource configuration is the same as a RACH configuration for the first cell or the second cell group means that the first signal shares a same time domain resource with a common RACH of the first cell or the second cell group;
(b) the signal frequency domain resource configuration is the same as a common random access channel RACH configuration for the first cell or the second cell group, where
for example, the signal frequency domain resource configuration is a first signal frequency domain resource configuration, and that the signal frequency domain resource configuration is the same as a RACH configuration for the first cell or the second cell group means that the first signal shares a same frequency domain resource with the common RACH of the first cell or the second cell group;
(c) the signal time domain resource configuration is a dedicated RACH configuration used for the first cell or the second cell group to trigger sending of the downlink reference signal, where
for example, that the signal time domain resource configuration is a dedicated RACH configuration used for the first cell or the second cell group to trigger sending of the downlink reference signal means that different time domain resources are used for the first signal and the common RACH of the first cell or the second cell group;
(d) the signal frequency domain resource configuration is a dedicated RACH configuration used for the first cell or the second cell group to trigger sending of the downlink reference signal, where
for example, that the signal frequency domain resource configuration is a dedicated RACH configuration used for the first cell or the second cell group to trigger sending of the downlink reference signal means that different frequency domain resources are used for the first signal and the common RACH of the first cell or the second cell group;
(e) the signal time domain resource configuration is a dedicated sounding reference signal SRS or physical uplink control channel PUCCH configuration used for the first cell or the second cell group to trigger sending of the downlink reference signal;
(f) the signal frequency domain resource configuration is a dedicated sounding reference signal SRS or physical uplink control channel PUCCH configuration used for the first cell or the second cell group to trigger sending of the downlink reference signal; and
(g) the signal sequence resource configuration is N sequence resources starting from a configured start sequence resource index.

For example, the first condition includes at least one of the following:
(a) synchronization information of the second cell group cannot be obtained based on the first cell or a fourth cell, where the fourth cell is a cell of the network side device, other than the first cell, in which the downlink reference signal is transmitted;
(b) the second cell group is not configured with a downlink reference signal sending parameter or has no downlink reference signal for sending;
(c) the intra-band cell of the second cell group is not configured with a downlink reference signal sending parameter or has no downlink reference signal for sending;
(d) the downlink reference signal sent in the second cell group does not meet a requirement of the terminal performing a target operation, where the target operation includes at least one of the following: a synchronization operation, a receiving operation, and a measurement operation;
(e) the second cell group is configured for sending the downlink reference signal on demand;
(f) the second cell group has the first parameter configuration information associated with the first signal, where
for example, the second cell group has a signal configuration, for triggering SSB transmission, corresponding to the first signal;
(g) the terminal obtains a configuration or indication information indicating that the second cell group is activated;
(h) the terminal obtains a configuration or indication information indicating that the second cell group is added as a secondary cell SCell;
(i) synchronization of the terminal in the second cell group fails;
(j) the terminal initiates random access in the second cell group;
(k) the terminal sends or receives data in the second cell group;
(l) a mobility status of the terminal changes; and
(m) the terminal performs measurement in the second cell group.

For example, that synchronization information of the second cell group cannot be obtained based on the first cell or a fourth cell includes:
(a) the second cell group and the first cell or the fourth cell are in different bands; and
(b) a frequency gap between the second cell group and the first cell or between the second cell group and the fourth cell is greater than or equal to a first threshold.

For example, after in the case that the first condition is met, the terminal sends the first signal to the network side device based on the first parameter configuration information, the terminal detects the downlink reference signal in a specific cell in the second cell group based on a target transmission parameter for the downlink reference signal of the second cell group.

The specific cell includes at least one of the following:
(a) a cell indicated by the first signal, where for example, an indication includes an explicit indication and an implicit indication, and the implicit indication is performed by using a resource location and an index of the first signal;
(b) the cell configured by the network side device in the second cell group;
(c) all the cells in the second cell group;
(d) the cell with the largest or smallest or middle cell index in the second cell group;
(e) the cell with the largest or smallest or middle cell center frequency in the second cell group; and
(f) the cell with the largest or smallest cell SCS in the second cell group.

According to the foregoing method, the terminal may detect the downlink reference signal in the specific cell in the second cell group based on the target transmission parameter for the downlink reference signal of the second cell group, to detect whether the first signal is successfully sent.

For example, the target transmission parameter includes at least one of the following:
(a) a downlink reference signal center frequency of the second cell group;
(b) a downlink reference signal sending periodicity of the second cell group;
(c) one or more time domain indexes or positions for actually sending the downlink reference signal of the second cell group;
(d) at least one of a time length for the downlink reference signal of the second cell group after sending of the downlink reference signal is triggered, a quantity of downlink reference signals, and a quantity of downlink reference signal periodicities;
(e) a relative relationship between the downlink reference signal of the second cell group and the downlink reference signal of the first cell in time domain, frequency domain, or space domain;
(f) a downlink reference signal sending form of the second cell group, where
for example, the downlink reference signal sending form of the second cell group includes a normal downlink reference signal actually sent (such as an SSB) and/or a power-saving downlink reference signal actually sent;
(g) time of a 1^{st} downlink reference signal sending periodicity for the downlink reference signal of the second cell group; and
(h) the downlink reference signal of the second cell group and the downlink reference signal of the first cell meet a quasi co-location QCL condition.

For example, the target transmission parameter is determined by using at least one of the following:
(a) configured by the network side device via the first cell;
(b) indicated by the first signal, where for example, an indication includes an explicit indication and an implicit indication, and the implicit indication is performed by using a resource location and an index of the first signal; and
(c) predefined in the protocol.

For example, after the terminal detects the downlink reference signal in the specific cell in the second cell group based on the transmission parameter for the downlink reference signal of the second cell group, in a case that a second condition is met, the terminal repeatedly sends the first signal to the network side device based on second parameter configuration information.

The second condition includes at least one of the following:
(a) detection on the downlink reference signal fails; and
(b) a quantity of repetitions of sending the first signal is less than or equal to the maximum quantity of repetitions of the first signal.

In the foregoing implementation, in the case that the second condition is met, the terminal repeatedly sends the first signal to the network side device based on the second parameter configuration information, which can avoid a case that the terminal fails to send the first signal.

For example, the second parameter configuration information includes at least one of the following:
(a) a second power configuration, including a signal initial power and/or a signal power step, where the signal initial power in the second power configuration is greater than the signal initial power in the first power configuration, and/or the signal power step in the second power configuration is greater than the signal power step in the first power configuration;
(b) an interval between repeated sending of the first signal and latest sending of the first signal is greater than or equal to a second threshold; and
(c) a second resource configuration, the same as the first resource configuration.

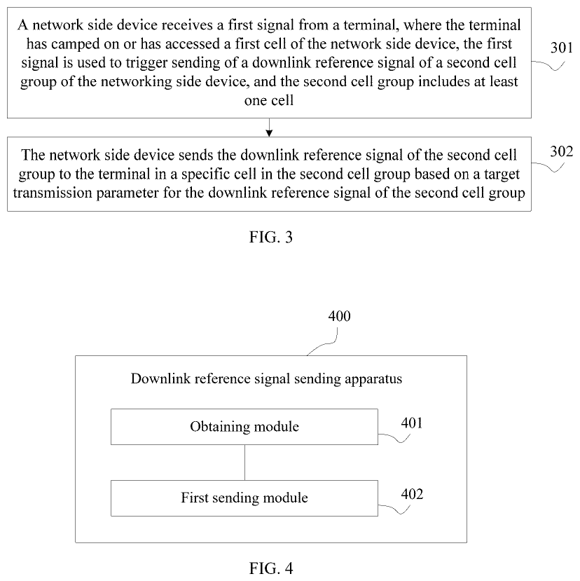

FIG. 3 is a second schematic flowchart of a downlink reference signal sending method according to an embodiment of this application. As shown in FIG. 3, the method includes steps 301 and 302.

Step 301: A network side device receives a first signal from a terminal, where the terminal has camped on or has accessed a first cell of the network side device, the first signal is used to trigger sending of a downlink reference signal of a second cell group of the networking side device, and the second cell group includes at least one cell.

It should be noted that this embodiment of this application may be applied to a scenario in which the network side device sends the downlink reference signal to the terminal in a case of multi-carrier deployment. The terminal includes but is not limited to the type of the foregoing listed terminal 11. This is not limited in this application. The network side device includes but is not limited to the type of the foregoing listed network side device 12. For example, the network side device includes at least one of the following: a core network node, an access network node (such as a base station), and a neural network processing node. The core network node is, for example, a Network Data Analytics Function (NWDAF) network element and/or a Location Management Function (LMF) network element. In this embodiment of this application, a cell may include a carrier, a cell group may include a carrier group, and a cell group may include at least one cell.

In a multi-carrier deployment scenario, a periodic synchronization reference signal is sent for each carrier, resulting in increased power consumption of the network side device (such as a base station). Therefore, in the multi-carrier deployment scenario, in this embodiment of this application, the network side device needs to receive the first signal from the terminal, to reduce power consumption of the base station, and reduce sending of the periodic downlink reference signal on the premise of ensuring performance of the terminal.

Step 302: The network side device sends the downlink reference signal of the second cell group to the terminal in a specific cell in the second cell group based on a target transmission parameter for the downlink reference signal of the second cell group.

After receiving the first signal from the terminal, the network side device needs to send the downlink reference signal of the second cell group to the terminal in the specific cell in the second cell group based on the target transmission parameter for the downlink reference signal of the second cell group.

The specific cell includes at least one of the following:
(a) a cell indicated by the first signal, where
for example, an indication includes an explicit indication and an implicit indication, and the implicit indication is performed by using a resource location and an index of the first signal; and
(b) a cell configured by the network side device in the second cell group;
(c) all cells in the second cell group;
(d) a cell with a largest or smallest or middle cell index in the second cell group;
(e) a cell with a largest or smallest or middle cell center frequency in the second cell group; and
(f) a cell with a largest or smallest cell subcarrier spacing SCS in the second cell group.

For example, the target transmission parameter includes at least one of the following:
(a) a downlink reference signal center frequency of the second cell group;
(b) a downlink reference signal sending periodicity of the second cell group;
(c) one or more time domain indexes or positions for actually sending the downlink reference signal of the second cell group;
(d) at least one of a time length for the downlink reference signal of the second cell group after sending of the downlink reference signal is triggered, a quantity of downlink reference signals, and a quantity of downlink reference signal periodicities;
(e) a relative relationship between the downlink reference signal of the second cell group and the downlink reference signal of the first cell in time domain, frequency domain, or space domain;
(f) a downlink reference signal sending form of the second cell group, where for example, the downlink reference signal sending form of the second cell group includes a normal downlink reference signal actually sent (such as an SSB) and/or a power-saving downlink reference signal actually sent; and
(g) time of a 1^{st} downlink reference signal sending periodicity for the downlink reference signal of the second cell group.

For example, the target transmission parameter is determined by using at least one of the following:
(a) configured by the network side device via the first cell;
(b) indicated by the first signal, where
for example, an indication includes an explicit indication and an implicit indication, and the implicit indication is performed by using a resource location and an index of the first signal; and
(c) predefined in the protocol.

In the downlink reference signal sending method provided in this embodiment of this application, the network side device receives the first signal from the terminal; and sends the downlink reference signal of the second cell group to the terminal in the specific cell in the second cell group based on the target transmission parameter for the downlink reference signal of the second cell group. That is, the network side device is enabled to reduce sending of the periodic downlink reference signal by using a mechanism of sending the downlink reference signal on demand, to reduce power consumption of the network side device and achieve an effect of network power saving.

To facilitate a clearer understanding of the downlink reference signal sending method provided in this embodiment of this application, the downlink reference signal sending method is further described and explained below in combination with Embodiment 1 and Embodiment 2.

### Embodiment 1

For a terminal with initial access or in an RRC idle state, the terminal obtains configuration information of Cell1, Cell2, Cell3, or Cell4 (that is, the first parameter configuration information mentioned above) through system information in Cell0. An example is provided.

Cell0: a band belongs to “Band”, and a transmission mode is normal SSB transmission mode.

Cell1: a band belongs to “Band1”, and a transmission mode is on-demand SSB transmission mode, which corresponds to a 1^{st} second carrier group (that is, the second cell group mentioned above).

Cell2: a band belongs to “Band1”, and a transmission mode is a no-SSB transmission mode.

Cell3 and Cell4: a band belongs to “Band2”, and a transmission mode is the on-demand SSB transmission mode, which corresponds to a 2nd second carrier group.

In addition, the following shows an example of a signal configuration for triggering SSB transmission in Cell0, and a resource is configured in Cell0 by using an SSB configuration request (ssb-RequestConfig).

For example, the following shows an example of content of SSB configuration request signaling:

| | |
|---|---|
| ssb-RequestConfig::= | SEQUENCE { |
| rach-OccasionsSsbRequest | SEQUENCE { |
| rach-ConfigSSBRequest | RACH-ConfigGeneric, |
| ssb-perRACH-Occasion | ENUMERATED {oneEighth, |

oneFourth,oneHalf,one,two,four,eight,sixteen}
}

| | |
|---|---|
| OPTIONAL, | -- Need R |

| | |
|---|---|
| ssb-RequestPeriod | ENUMERATED {one, two, four, six, |

| | |
|---|---|
| eight, ten, twelve, sixteen} | OPTIONAL, -- Need R |

| | |
|---|---|
| ssb-RequestResources | SEQUENCE (SIZE |

(1..maxssbRequest-Message)) OF ssb-RequestResources
}

| ssb-RequestResources ::= | | SEQUENCE { |
|---|---|---|
| ra-PreambleStartIndex | | INTEGER (0..63), |
| ra-AssociationPeriodIndex | | INTEGER (0..15) |
| OPTIONAL, | -- Need R | |
| ra-ssb-OccasionMaskIndex | | INTEGER (0..15) |

| | |
|---|---|
| OPTIONAL | -- Need R |

}

rach-OccasionsSsbRequest is a candidate signal resource set and is a dedicated RACH configuration, ssb-RequestPeriod is a trigger signal periodicity configuration, and ssb-RequestResources is a configuration resource list. Each resource item corresponds to a carrier group configured as the on-demand SSB transmission mode. For example, two resources are configured by using ssb-RequestResources, and respectively correspond to the 1^{st} second carrier group (Cell1) and the 2^{nd} second carrier group (Cell3 and Cell4).

When the terminal meets the following first condition, the terminal sends a RACH on a corresponding resource configured in Cell0. After receiving the RACH, a base station sends an SSB in Cell1 according to configuration information.
(1) The second carrier group is configured as the on-demand SSB transmission mode.
(2) The terminal needs to initiate random access in the second carrier group.

For example, the SSB in Cell1 lasts for T periodicities starting from a 1^{st} periodicity after a period of time when the RACH is sent.

For example, the SSB in Cell1 and an SSB in Cell0 meet a QCL condition, that is, SSBs with a same index have a same sending direction and the like, and only an SSB corresponding to the RACH is sent in Cell1 after the RACH is received.

After sending the RACH, the terminal detects the SSB according to the configuration. In a case that the SSB detection fails within a period of time, the terminal re-sends the RACH.

### Embodiment 2

A terminal obtains configuration information of Cell1, Cell2, Cell3, and Cell4 on an operating first carrier Cell0. An example is provided.

Cell0: a carrier type is “PCell”, a band belongs to “Band0”, and a transmission mode is normal SSB transmission mode.

Cell1: a carrier type is “SCell”, a band belongs to “Band1”, and a transmission mode is an on-demand SSB transmission mode, which corresponds to a 1^{st} second carrier group.

Cell2: a carrier type is “SCell”, a band belongs to “Band1”, and a transmission mode is a no-SSB transmission mode, which corresponds to a 2nd second carrier group.

Cell3 and Cell4: a carrier type is “SCell”, a band belongs to “Band2”, and a transmission mode is the on-demand SSB transmission mode, which corresponds to a 3^{rd} second carrier group.

In addition, the following shows an example of a signal configuration for triggering SSB transmission in Cell0, and a resource is configured in Cell0 by using ssb-RequestConfig.

For example, the following shows an example of content of SSB configuration request signaling:

| | |
|---|---|
| ssb-RequestConfig::= | SEQUENCE { |
| rach-OccasionsSsbRequest | SEQUENCE { |
| rach-ConfigSSBRequest | RACH-ConfigGeneric, |
| ssb-perRACH-Occasion | ENUMERATED {oneEighth, |

oneFourth, oneHalf, one, two, four, eight, sixteen}
}

| OPTIONAL, | -- Need R | |
|---|---|---|
| ssb-RequestPeriod | | ENUMERATED {one, two, four, six, |
| eight, ten, twelve, sixteen} | OPTIONAL, -- Need R | |
| ssb-RequestResources | | SEQUENCE (SIZE |

(1..maxssbRequest-Message)) OF ssb-RequestResources
}

| | |
|---|---|
| ssb-RequestResources ::= | SEQUENCE { |
| ra-PreambleStartIndex | INTEGER (0..63), |
| ra-AssociationPeriodIndex | INTEGER (0..15) |

| | |
|---|---|
| OPTIONAL, | -- Need R |

| | |
|---|---|
| ra-ssb-OccasionMaskIndex | INTEGER (0..15) |

| | |
|---|---|
| OPTIONAL | -- Need R |

}

rach-OccasionsSsbRequest is a candidate signal resource set and is a dedicated RACH configuration, ssb-RequestPeriod is a trigger signal periodicity configuration, and ssb-RequestResources is a configuration resource list. Each resource item corresponds to a carrier configured as the on-demand SSB transmission mode. For example, two resources are configured by using ssb-RequestResources, and respectively correspond to Cell1 and Cell3.

When data needs to be sent or received in Cell1, the terminal sends a RACH on a corresponding resource configured in Cell0. After receiving the RACH, a base station sends an SSB in Cell1 according to configuration information.

For example, the SSB in Cell1 lasts for T periodicities starting from a 1^{st} periodicity after a period of time when the RACH is sent.

For example, the SSB in Cell1 and an SSB in Cell0 meet a QCL condition, that is, SSBs with a same index have a same sending direction and the like, and only an SSB corresponding to the RACH is sent in Cell1 after the RACH is received.

After sending the RACH, the terminal detects the SSB according to the configuration. In a case that the SSB detection fails within a period of time, the terminal re-sends the RACH.

### Embodiment 3

A terminal obtains configuration information of Cell1, Cell2, Cell3, and Cell4 on an operating first carrier Cell0. An example is provided.

Cell0: a carrier type is “PCell”, a band belongs to “Band0”, and a transmission mode is normal SSB transmission mode.

Cell1: a carrier type is “SCell”, a band belongs to “Band1”, and a transmission mode is an on-demand SSB transmission mode, which corresponds to a 1^{st} second carrier group.

Cell2: a carrier type is “SCell”, a band belongs to “Band1”, and a transmission mode is a no-SSB transmission mode, which corresponds to a 2^{nd} second carrier group.

Cell3 and Cell4: a carrier type is “SCell”, a band belongs to “Band2”, and a transmission mode is the on-demand SSB transmission mode, which corresponds to a 3^{rd} second carrier group.

Configuration information of Cell1 includes corresponding ssb-RequestConfig information, a resource is configured in Cell1 by using the ssb-RequestConfig information, and a synchronization reference of the resource is an SSB in Cell0.

Configuration information of Cell3 includes corresponding ssb-RequestConfig information, a resource is configured in Cell3 by using the ssb-RequestConfig information, and a synchronization reference of the resource is an SSB in Cell0.

When data needs to be sent or received in Cell1, the terminal sends a request signal on a corresponding resource configured in Cell1.

For example, the request signal is repeatedly sent to a base station for scanning and receiving.

After receiving the request signal, the base station sends an SSB in Cell1 according to the configuration information.

For example, the SSB in Cell1 lasts for T periodicities starting from a 1^{st} periodicity after a period of time when the RACH is sent.

For example, the SSB in Cell1 has mapping with the request signal, and only an SSB corresponding to the request signal is sent in Cell1 after the request signal is received.

After sending the RACH, the terminal detects the SSB according to the configuration. In a case that the SSB detection fails within a period of time, the terminal re-sends the RACH.

The downlink reference signal sending method provided in the embodiments of this application may be performed by a downlink reference signal sending apparatus. In the embodiments of this application, the downlink reference signal sending apparatus provided in the embodiments of this application is described by using an example in which the downlink reference signal sending apparatus performs the downlink reference signal sending method.

FIG. 4 is a first schematic diagram of a structure of a downlink reference signal sending apparatus according to an embodiment of this application. As shown in FIG. 4, the downlink reference signal sending apparatus 400 is applied to a terminal, and includes:
an obtaining module 401, configured to obtain first parameter configuration information associated with a first signal; and
a first sending module 402, configured to: in a case that a first condition is met, send the first signal to a network side device in a target cell based on the first parameter configuration information.

The terminal has camped on or has accessed a first cell of the network side device, the first signal is used to trigger sending of a downlink reference signal of a second cell group of the networking side device, and the second cell group includes at least one cell.

The downlink reference signal sending apparatus provided in this embodiment of this application obtains the first parameter configuration information associated with the first signal; and in the case that the first condition is met, sends the first signal to the network side device in the target cell based on the first parameter configuration information, to trigger the network side device to send the downlink reference signal of the second cell group to the terminal. That is, in a case that the network side device receives the first signal from the terminal, the network side device sends the downlink reference signal of the second cell group to the terminal. The network side device is enabled to reduce sending of the periodic downlink reference signal by using a mechanism of sending the downlink reference signal on demand, to reduce power consumption of the network side device and achieve an effect of network power saving.

For example, the first parameter configuration information includes at least one of the following:
a synchronization reference signal configuration;
a signal type;
a first resource configuration, including at least one of the following: a signal time domain resource configuration, a signal frequency domain resource configuration, and a signal sequence resource configuration;
a first power configuration, including a signal initial power and/or a signal power step;
a signal repetition configuration, including a repetition quantity corresponding to each time of sending the first signal and/or a maximum quantity of repetitions of the first signal; and
a signal space domain parameter configuration, including a correspondence between the first signal and a downlink reference signal of the first cell or between the first signal and the downlink reference signal of the second cell group.

For example, the synchronization reference signal configuration includes at least one of the following:
the downlink reference signal of the first cell;
a downlink reference signal sent in an intra-band cell of the second cell group;
a downlink reference signal of a third cell, where the third cell is a cell configured by the network side device and/or predefined in a protocol for the terminal to send the first signal;
a downlink reference signal sent in an intra-band cell of the third cell; and
global positioning system timing GPS timing.

For example, the first resource configuration is obtained by using at least one of the following:
configuring a signal resource list in the first cell, where each entry in the signal resource list one-to-one corresponds, in an order of cell group indexes, to each cell group configured for sending a downlink reference signal on demand in the second cell group, or each entry in the signal resource list corresponds to an index of a cell group in the second cell group, and any entry in the signal resource list includes at least one resource;
configuring a candidate signal resource set in the first cell, where a candidate signal resource of at least one periodicity in the candidate signal resource set is numbered in a combination order of any one of a time domain, a frequency domain, and a code domain, and a granularity of at least one candidate signal resource one-to-one corresponds, in an order of cell indexes or cell group indexes, to a cell or a cell group configured for sending a downlink reference signal on demand; and
separately configuring at least one resource of the target cell in a cell configuration of the second cell group by the first cell.

For example, the candidate signal resource is obtained by using at least one of the following:
the signal time domain resource configuration is the same as a common random access channel RACH configuration for the first cell or the second cell group;
the signal frequency domain resource configuration is the same as a common random access channel RACH configuration for the first cell or the second cell group;
the signal time domain resource configuration is a dedicated RACH configuration used for the first cell or the second cell group to trigger sending of the downlink reference signal;
the signal frequency domain resource configuration is a dedicated RACH configuration used for the first cell or the second cell group to trigger sending of the downlink reference signal;
the signal time domain resource configuration is a dedicated sounding reference signal SRS or physical uplink control channel PUCCH configuration used for the first cell or the second cell group to trigger sending of the downlink reference signal;
the signal frequency domain resource configuration is a dedicated sounding reference signal SRS or physical uplink control channel PUCCH configuration used for the first cell or the second cell group to trigger sending of the downlink reference signal; and the signal sequence resource configuration is N sequence resources starting from a configured start sequence resource index.

For example, the first condition includes at least one of the following:
synchronization information of the second cell group cannot be obtained based on the first cell or a fourth cell, where the fourth cell is a cell of the network side device, other than the first cell, in which the downlink reference signal is transmitted;
the second cell group is not configured with a downlink reference signal sending parameter or has no downlink reference signal for sending;
the intra-band cell of the second cell group is not configured with a downlink reference signal sending parameter or has no downlink reference signal for sending;
the downlink reference signal sent in the second cell group does not meet a requirement of the terminal performing a target operation, where the target operation includes at least one of the following: a synchronization operation, a receiving operation, and a measurement operation; the second cell group is configured for sending the downlink reference signal on demand;
the second cell group has the first parameter configuration information associated with the first signal;
the terminal obtains a configuration or indication information indicating that the second cell group is activated;
the terminal obtains a configuration or indication information indicating that the second cell group is added as a secondary cell SCell;
synchronization of the terminal in the second cell group fails;
the terminal initiates random access in the second cell group;
the terminal sends or receives data in the second cell group;
a mobility status of the terminal changes; and
the terminal performs measurement in the second cell group.

For example, that synchronization information of the second cell group cannot be obtained based on the first cell or a fourth cell includes:
the second cell group and the first cell or the fourth cell are in different bands; and
a frequency gap between the second cell group and the first cell or between the second cell group and the fourth cell is greater than or equal to a first threshold.

For example, the target cell includes at least one of the following:
the first cell;
a cell configured by the network side device in the second cell group;
all cells in the second cell group;
a cell with a largest or smallest or middle cell index in the second cell group;
a cell with a largest or smallest or middle cell center frequency in the second cell group; and
a cell with a largest or smallest cell subcarrier spacing SCS in the second cell group; and
a cell configured by the network side device and/or predefined in the protocol for the terminal to send the first signal.

For example, the apparatus further includes:

a detection module, configured to detect the downlink reference signal in a specific cell in the second cell group based on a target transmission parameter for the downlink reference signal of the second cell group.

The specific cell includes at least one of the following:
a cell indicated by the first signal;
the cell configured by the network side device in the second cell group;
all the cells in the second cell group;
the cell with the largest or smallest or middle cell index in the second cell group;
the cell with the largest or smallest or middle cell center frequency in the second cell group; and
the cell with the largest or smallest cell SCS in the second cell group.

For example, the target transmission parameter includes at least one of the following:
a downlink reference signal center frequency of the second cell group;
a downlink reference signal sending periodicity of the second cell group;
one or more time domain indexes or positions for actually sending the downlink reference signal of the second cell group;
at least one of a time length for the downlink reference signal of the second cell group after sending of the downlink reference signal is triggered, a quantity of downlink reference signals, and a quantity of downlink reference signal periodicities;
a relative relationship between the downlink reference signal of the second cell group and the downlink reference signal of the first cell in time domain, frequency domain, or space domain;
a downlink reference signal sending form of the second cell group;
time of a 1^{st} downlink reference signal sending periodicity for the downlink reference signal of the second cell group; and
the downlink reference signal of the second cell group and the downlink reference signal of the first cell meet a quasi co-location QCL condition.

For example, the target transmission parameter is determined by using at least one of the following:
configured by the network side device via the first cell;
indicated by the first signal; and
predefined in the protocol.

For example, a cell in the second cell group includes at least one of the following:
a cell in a same band;
a cell configured by the network side device;
a cell with a same SCS of an initial bandwidth part Initial BWP;
a cell with a same SCS of an active BWP; and
a cell with a same SCS of a synchronization signal and physical broadcast channel block SSB.

For example, the apparatus further includes:
a third sending module, configured to: in a case that a second condition is met, repeatedly send the first signal to the network side device based on second parameter configuration information.

The second condition includes at least one of the following:
detection on the downlink reference signal fails; and
a quantity of repetitions of sending the first signal is less than or equal to the maximum quantity of repetitions of the first signal.

For example, the second parameter configuration information includes at least one of the following:
a second power configuration, including a signal initial power and/or a signal power step, where the signal initial power in the second power configuration is greater than the signal initial power in the first power configuration, and/or the signal power step in the second power configuration is greater than the signal power step in the first power configuration;
an interval between repeated sending of the first signal and latest sending of the first signal is greater than or equal to a second threshold; and
a second resource configuration, the same as the first resource configuration.

For example, the downlink reference signal includes at least one of the following:
a synchronization signal and physical broadcast channel block SSB;
a tracking reference signal TRS; and
a channel state information reference signal CSI-RS.

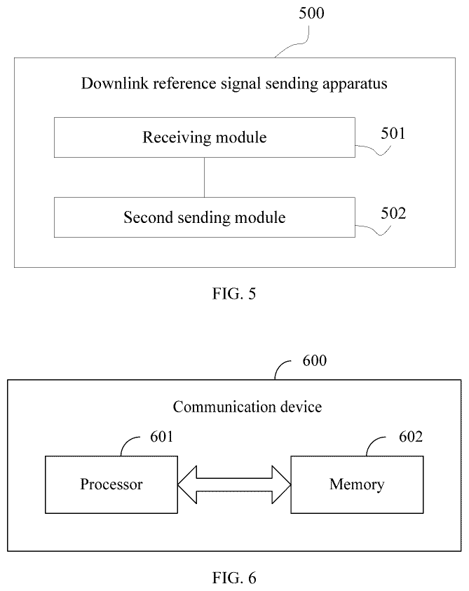

FIG. 5 is a second schematic diagram of a structure of a downlink reference signal sending apparatus according to an embodiment of this application. As shown in FIG. 5, the downlink reference signal sending apparatus 500 is applied to a network side device, and includes:
a receiving module 501, configured to receive a first signal from a terminal, where the terminal has camped on or has accessed a first cell of the network side device, the first signal is used to trigger sending of a downlink reference signal of a second cell group of the networking side device, and the second cell group includes at least one cell; and
a second sending module 502, configured to send the downlink reference signal of the second cell group to the terminal in a specific cell in the second cell group based on a target transmission parameter for the downlink reference signal of the second cell group.

The specific cell includes at least one of the following:
a cell indicated by the first signal;
a cell configured by the network side device in the second cell group;
all cells in the second cell group;
a cell with a largest or smallest or middle cell index in the second cell group;
a cell with a largest or smallest or middle cell center frequency in the second cell group; and
a cell with a largest or smallest cell subcarrier spacing SCS in the second cell group.

The downlink reference signal sending apparatus provided in this embodiment of this application receives the first signal from the terminal; and sends the downlink reference signal of the second cell group to the terminal in the specific cell in the second cell group based on the target transmission parameter for the downlink reference signal of the second cell group. That is, the network side device is enabled to reduce sending of the periodic downlink reference signal by using a mechanism of sending the downlink reference signal on demand, to reduce power consumption of the network side device and achieve an effect of network power saving.

The downlink reference signal sending apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The downlink reference signal sending apparatus provided in this embodiment of this application can implement the processes implemented in the method embodiments in FIG. 2 and FIG. 3, and a same technical effect can be achieved. To avoid repetition, details are not described herein again.

FIG. 6 is a schematic diagram of a structure of a communication device according to an embodiment of this application. As shown in FIG. 6, the communication device 600 includes a processor 601 and a memory 602. The memory 602 stores a program or an instruction executable on the processor 601. For example, when the communication device 600 is a terminal, the program or the instruction is executed by the processor 601 to implement the steps of the foregoing downlink reference signal sending method embodiments, and a same technical effect can be achieved. When the communication device 600 is a network side device, the program or the instruction is executed by the processor 601 to implement the steps of the foregoing downlink reference signal sending method embodiments, and a same technical effect can be achieved. To avoid repetition, details are not described herein again.

An embodiment of this application further provides a terminal, including a processor and a communication interface. The processor is configured to obtain first parameter configuration information associated with a first signal. The communication interface is configured to: in a case that a first condition is met, send the first signal to a network side device in a target cell based on the first parameter configuration information. The terminal has camped on or has accessed a first cell of the network side device, the first signal is used to trigger sending of a downlink reference signal of a second cell group of the networking side device, and the second cell group includes at least one cell. The terminal embodiment corresponds to the terminal side method embodiment, each implementation process and implementation of the method embodiment can be applied to the terminal embodiment, and a same technical effect can be achieved.

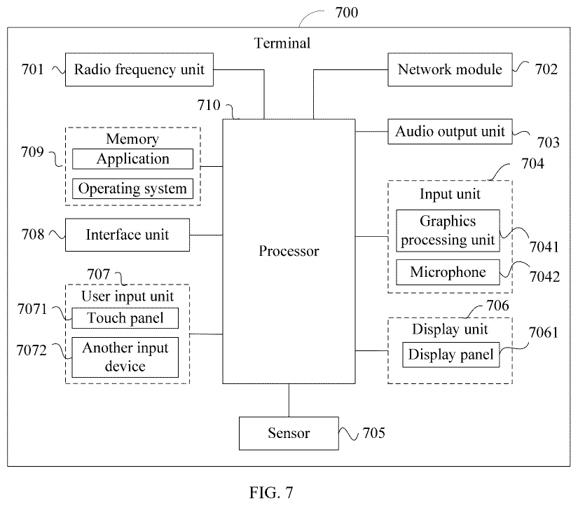

FIG. 7 is a schematic diagram of a structure of a terminal according to an embodiment of this application. As shown in FIG. 7, the terminal 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that in this embodiment of this application, the input unit 704 may include a Graphics Processing Unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Generally, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 709 in this embodiment of this application includes but is not limited to these memories and any memory of another proper type.

The processor 710 may include one or more processing units. For example, an application processor and a modem processor are integrated into the processor 710. The application processor mainly processes an operating system, a user interface, an application, or the like. The modem processor mainly processes a wireless communication signal, for example, a baseband processor. For example, it may be understood that, the modem processor may not be integrated into the processor 710.

The processor 710 is configured to obtain first parameter configuration information associated with a first signal.

The radio frequency unit 701 is configured to: in a case that a first condition is met, send the first signal to a network side device in a target cell based on the first parameter configuration information. The terminal has camped on or has accessed a first cell of the network side device, the first signal is used to trigger sending of a downlink reference signal of a second cell group of the networking side device, and the second cell group includes at least one cell.

In this embodiment of this application, the processor obtains the first parameter configuration information associated with the first signal; and in the case that the first condition is met, the radio frequency unit sends the first signal to the network side device in the target cell based on the first parameter configuration information, to trigger the network side device to send the downlink reference signal of the second cell group to the terminal. That is, in a case that the network side device receives the first signal from the terminal, the network side device sends the downlink reference signal of the second cell group to the terminal. The network side device is enabled to reduce sending of the periodic downlink reference signal by using a mechanism of sending the downlink reference signal on demand, to reduce power consumption of the network side device and achieve an effect of network power saving.

An embodiment of this application further provides a network side device, including a processor and a communication interface. The communication interface is configured to:
receive a first signal from a terminal, where the terminal has camped on or has accessed a first cell of the network side device, the first signal is used to trigger sending of a downlink reference signal of a second cell group of the networking side device, and the second cell group includes at least one cell; and
send the downlink reference signal of the second cell group to the terminal in a specific cell in the second cell group based on a target transmission parameter for the downlink reference signal of the second cell group.

The specific cell includes at least one of the following:
a cell indicated by the first signal;
a cell configured by the network side device in the second cell group;
all cells in the second cell group;
a cell with a largest or smallest or middle cell index in the second cell group;
a cell with a largest or smallest or middle cell center frequency in the second cell group; and
a cell with a largest or smallest cell subcarrier spacing SCS in the second cell group.

The network side device embodiment corresponds to the method embodiment of the network side device, each implementation process and implementation of the method embodiment can be applied to the network side device embodiment, and a same technical effect can be achieved.

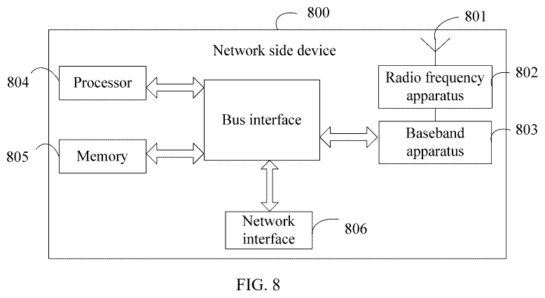

FIG. 8 is a schematic diagram of a structure of a network side device according to an embodiment of this application. As shown in FIG. 8, the network side device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information through the antenna 801, and sends the received information to the baseband apparatus 803 for processing. In a downlink direction, the baseband apparatus 803 processes information that needs to be sent, and sends processed information to the radio frequency apparatus 802. The radio frequency apparatus 802 processes the received information, and sends processed information through the antenna 801.

In the foregoing embodiment, the method performed by the network side device may be implemented in the baseband apparatus 803. The baseband apparatus 803 includes a baseband processor.

For example, the baseband apparatus 803 may include at least one baseband board. A plurality of chips are disposed on the baseband board. As shown in FIG. 8, one chip is, for example, a baseband processor, and is connected to the memory 805 by using a bus interface, to invoke a program in the memory 805 to perform the operations of the network device shown in the foregoing method embodiment.

The network side device may further include a network interface 806, and the interface is, for example, a Common Public Radio Interface (CPRI).

For example, the network side device 800 in this embodiment of the present disclosure further includes an instruction or a program that is stored in the memory 805 and that is executable on the processor 804. The processor 804 invokes the instruction or the program in the memory 805 to perform the downlink reference signal sending method, and a same technical effect is achieved. To avoid repetition, details are not described herein.

An embodiment of this application further provides a downlink reference signal sending system, including a terminal and a network side device. The terminal may be configured to perform the steps of the downlink reference signal sending method described in FIG. 2, and the network side device may be configured to perform the steps of the downlink reference signal sending method described in FIG. 3.

An embodiment of this application further provides a readable storage medium. The readable storage medium may be volatile or non-volatile. The readable storage medium stores a program or an instruction, and the program or the instruction is executed by a processor to implement the processes of the foregoing downlink reference signal sending method embodiments, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing downlink reference signal sending method embodiments, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing downlink reference signal sending method embodiments, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is an example implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A downlink reference signal sending method, comprising:
obtaining, by a terminal, first parameter configuration information associated with a first signal; and
when a first condition is met, sending, by the terminal, the first signal to a network side device in a target cell based on the first parameter configuration information, wherein
the terminal has camped on or has accessed a first cell of the network side device, the first signal is used to trigger sending of a downlink reference signal of a second cell group of the networking side device, and the second cell group comprises at least one cell.

2. The downlink reference signal sending method according to claim 1, wherein the first parameter configuration information comprises at least one of the following:
a synchronization reference signal configuration;
a signal type;
a first resource configuration, comprising at least one of the following: a signal time domain resource configuration, a signal frequency domain resource configuration, or a signal sequence resource configuration;
a first power configuration, comprising a signal initial power or a signal power step;
a signal repetition configuration, comprising a repetition quantity corresponding to each time of sending the first signal or a maximum quantity of repetitions of the first signal; or
a signal space domain parameter configuration, comprising a correspondence between the first signal and a downlink reference signal of the first cell or between the first signal and the downlink reference signal of the second cell group.

3. The downlink reference signal sending method according to claim 2, wherein the synchronization reference signal configuration comprises at least one of the following:
the downlink reference signal of the first cell;
a downlink reference signal sent in an intra-band cell of the second cell group;
a downlink reference signal of a third cell, wherein the third cell is a cell configured by the network side device or predefined in a protocol for the terminal to send the first signal;
a downlink reference signal sent in an intra-band cell of the third cell; or
global positioning system timing GPS timing.

4. The downlink reference signal sending method according to claim 2, wherein the first resource configuration is obtained by using at least one of the following:
configuring a signal resource list in the first cell, wherein each entry in the signal resource list one-to-one corresponds, in an order of cell group indexes, to each cell group configured for sending a downlink reference signal on demand in the second cell group, or each entry in the signal resource list corresponds to an index of a cell group in the second cell group, and any entry in the signal resource list comprises at least one resource;
configuring a candidate signal resource set in the first cell, wherein a candidate signal resource of at least one periodicity in the candidate signal resource set is numbered in a combination order of any one of a time domain, a frequency domain, or a code domain, and a granularity of at least one candidate signal resource one-to-one corresponds, in an order of cell indexes or cell group indexes, to a cell or a cell group configured for sending a downlink reference signal on demand; or
separately configuring at least one resource of the target cell in a cell configuration of the second cell group by the first cell.

5. The downlink reference signal sending method according to claim 4, wherein the candidate signal resource is obtained by using at least one of the following:
the signal time domain resource configuration is the same as a common Random Access Channel (RACH) configuration for the first cell or the second cell group;
the signal frequency domain resource configuration is the same as a common RACH configuration for the first cell or the second cell group;
the signal time domain resource configuration is a dedicated RACH configuration used for the first cell or the second cell group to trigger sending of the downlink reference signal;
the signal frequency domain resource configuration is a dedicated RACH configuration used for the first cell or the second cell group to trigger sending of the downlink reference signal;
the signal time domain resource configuration is a dedicated Sounding Reference Signal (SRS) or Physical Uplink Control Channel (PUCCH) configuration used for the first cell or the second cell group to trigger sending of the downlink reference signal;
the signal frequency domain resource configuration is a dedicated SRS or PUCCH configuration used for the first cell or the second cell group to trigger sending of the downlink reference signal; or
the signal sequence resource configuration is N sequence resources starting from a configured start sequence resource index.

6. The downlink reference signal sending method according to claim 1, wherein the first condition comprises at least one of the following:
synchronization information of the second cell group cannot be obtained based on the first cell or a fourth cell, wherein the fourth cell is a cell of the network side device, other than the first cell, in which the downlink reference signal is transmitted;
the second cell group is not configured with a downlink reference signal sending parameter or has no downlink reference signal for sending;
the intra-band cell of the second cell group is not configured with a downlink reference signal sending parameter or has no downlink reference signal for sending;
the downlink reference signal sent in the second cell group does not meet a requirement of the terminal performing a target operation, wherein the target operation comprises at least one of the following: a synchronization operation, a receiving operation, or a measurement operation;
the second cell group is configured for sending the downlink reference signal on demand;
the second cell group has the first parameter configuration information associated with the first signal;
the terminal obtains configuration or indication information indicating that the second cell group is activated;
the terminal obtains configuration or indication information indicating that the second cell group is added as a secondary cell SCell;
synchronization of the terminal in the second cell group fails;
the terminal initiates random access in the second cell group;
the terminal sends or receives data in the second cell group;
a mobility status of the terminal changes; or
the terminal performs measurement in the second cell group.

7. The downlink reference signal sending method according to claim 6, wherein the synchronization information of the second cell group cannot be obtained based on the first cell or a fourth cell comprises:
the second cell group and the first cell or the fourth cell are in different bands; and
a frequency gap between the second cell group and the first cell or between the second cell group and the fourth cell is greater than or equal to a first threshold.

8. The downlink reference signal sending method according to claim 1, wherein the target cell comprises at least one of the following:
the first cell;
a cell configured by the network side device in the second cell group;
all cells in the second cell group;
a cell with a largest or smallest or middle cell index in the second cell group;
a cell with a largest or smallest or middle cell center frequency in the second cell group;
a cell with a largest or smallest cell Subcarrier Spacing (SCS) in the second cell group; or
a cell configured by the network side device or predefined in the protocol for the terminal to send the first signal.

9. The downlink reference signal sending method according to claim 2, further comprising:
detecting, by the terminal, the downlink reference signal in a specific cell in the second cell group based on a target transmission parameter for the downlink reference signal of the second cell group, wherein
the specific cell comprises at least one of the following:
a cell indicated by the first signal;
the cell configured by the network side device in the second cell group;
all the cells in the second cell group;
the cell with the largest or smallest or middle cell index in the second cell group;
the cell with the largest or smallest or middle cell center frequency in the second cell group; or
the cell with the largest or smallest cell SCS in the second cell group.

10. The downlink reference signal sending method according to claim 9, wherein the target transmission parameter comprises at least one of the following:
a downlink reference signal center frequency of the second cell group;
a downlink reference signal sending periodicity of the second cell group;
one or more time domain indexes or positions for actually sending the downlink reference signal of the second cell group;
at least one of a time length for the downlink reference signal of the second cell group after sending of the downlink reference signal is triggered, a quantity of downlink reference signals, or a quantity of downlink reference signal periodicities;
a relative relationship between the downlink reference signal of the second cell group and the downlink reference signal of the first cell in time domain, frequency domain, or space domain;
a downlink reference signal sending form of the second cell group;
time of a first downlink reference signal sending periodicity for the downlink reference signal of the second cell group; or
the downlink reference signal of the second cell group and the downlink reference signal of the first cell meet a quasi co-location QCL condition.

11. The downlink reference signal sending method according to claim 9, wherein the target transmission parameter is determined by using at least one of the following:
configured by the network side device via the first cell;
indicated by the first signal; or
predefined in the protocol.

12. The downlink reference signal sending method according to claim 1, wherein a cell in the second cell group comprises at least one of the following:
a cell in a same band;
a cell configured by the network side device;
a cell with a same SCS of an initial Bandwidth Part (BWP);
a cell with a same SCS of an active BWP; or
a cell with a same SCS of a Synchronization Signal and Physical Broadcast Channel Block (SSB).

13. The downlink reference signal sending method according to claim 9, further comprising:
when a second condition is met, repeatedly sending, by the terminal, the first signal to the network side device based on second parameter configuration information, wherein
the second condition comprises at least one of the following:
detection on the downlink reference signal fails; or
a quantity of repetitions of sending the first signal is less than or equal to the maximum quantity of repetitions of the first signal.

14. The downlink reference signal sending method according to claim 13, wherein the second parameter configuration information comprises at least one of the following:
a second power configuration, comprising a signal initial power or a signal power step, wherein the signal initial power in the second power configuration is greater than the signal initial power in the first power configuration, or the signal power step in the second power configuration is greater than the signal power step in the first power configuration;
an interval between repeated sending of the first signal and latest sending of the first signal is greater than or equal to a second threshold; or
a second resource configuration, the same as the first resource configuration.

15. The downlink reference signal sending method according to claim 1, wherein the downlink reference signal comprises at least one of the following:
a synchronization signal and physical SSB;
a Tracking Reference Signal (TRS); or
a Channel State Information Reference Signal (CSI-RS).

16. A downlink reference signal sending method, comprising:
receiving, by a network side device, a first signal from a terminal, wherein the terminal has camped on or has accessed a first cell of the network side device, the first signal is used to trigger sending of a downlink reference signal of a second cell group of the networking side device, and the second cell group comprises at least one cell; and
sending, by the network side device, the downlink reference signal of the second cell group to the terminal in a specific cell in the second cell group based on a target transmission parameter for the downlink reference signal of the second cell group, wherein
the specific cell comprises at least one of the following:
a cell indicated by the first signal;
a cell configured by the network side device in the second cell group;
all cells in the second cell group;
a cell with a largest or smallest or middle cell index in the second cell group;
a cell with a largest or smallest or middle cell center frequency in the second cell group; or
a cell with a largest or smallest cell subcarrier spacing SCS in the second cell group.

17. A terminal, comprising a processor and a memory storing instructions, wherein the instructions, when executed by the processor, cause the processor to perform operations comprising:
obtaining first parameter configuration information associated with a first signal; and
when a first condition is met, sending the first signal to a network side device in a target cell based on the first parameter configuration information, wherein
the terminal has camped on or has accessed a first cell of the network side device, the first signal is used to trigger sending of a downlink reference signal of a second cell group of the networking side device, and the second cell group comprises at least one cell.

18. The terminal according to claim 17, wherein the first parameter configuration information comprises at least one of the following:
a synchronization reference signal configuration;
a signal type;
a first resource configuration, comprising at least one of the following: a signal time domain resource configuration, a signal frequency domain resource configuration, or a signal sequence resource configuration;
a first power configuration, comprising a signal initial power or a signal power step;
a signal repetition configuration, comprising a repetition quantity corresponding to each time of sending the first signal or a maximum quantity of repetitions of the first signal; or
a signal space domain parameter configuration, comprising a correspondence between the first signal and a downlink reference signal of the first cell or between the first signal and the downlink reference signal of the second cell group.

19. The terminal according to claim 18, wherein the synchronization reference signal configuration comprises at least one of the following:
the downlink reference signal of the first cell;
a downlink reference signal sent in an intra-band cell of the second cell group;
a downlink reference signal of a third cell, wherein the third cell is a cell configured by the network side device or predefined in a protocol for the terminal to send the first signal;
a downlink reference signal sent in an intra-band cell of the third cell; or
global positioning system timing GPS timing.

20. The terminal according to claim 18, wherein the first resource configuration is obtained by using at least one of the following:
configuring a signal resource list in the first cell, wherein each entry in the signal resource list one-to-one corresponds, in an order of cell group indexes, to each cell group configured for sending a downlink reference signal on demand in the second cell group, or each entry in the signal resource list corresponds to an index of a cell group in the second cell group, and any entry in the signal resource list comprises at least one resource;
configuring a candidate signal resource set in the first cell, wherein a candidate signal resource of at least one periodicity in the candidate signal resource set is numbered in a combination order of any one of a time domain, a frequency domain, or a code domain, and a granularity of at least one candidate signal resource one-to-one corresponds, in an order of cell indexes or cell group indexes, to a cell or a cell group configured for sending a downlink reference signal on demand; or
separately configuring at least one resource of the target cell in a cell configuration of the second cell group by the first cell.
